(19) United States
(12) Patent Application Publication
(10) Pub. No.: US 2026/0231943 A1
(43) Pub. Date: Aug. 13, 2026

(54) KINETIN COMPOSITIONS AND USES THEREOF

(71) Applicant: Valent BioSciences LLC, Libertyville, IL (US)

(72) Inventors: Hanwei Zhang, Port Barrington, IL (US); Yueqian Zhen, Gurnee, IL (US)

(21) Appl. No.: 19/533,515

(22) Filed: Feb. 9, 2026

Related U.S. Application Data
(60) Provisional application No. 63/756,425, filed on Feb. 10, 2025.

(51) Int. Cl. A01N 43/90; A01N 25/02; A01P 21/00

(52) U.S. Cl. CPC A01N 43/90; A01N 25/02; A01P 21/00

(57) ABSTRACT

The present invention is directed to an agricultural composition comprising kinetin or salts, derivatives or conjugates thereof and an acid selected from the group consisting of hydrochloric acid, citric acid, sulfuric acid and mixtures thereof. The present invention is further directed to methods of improving plant growth comprising applying a composition of the present invention to a plant.

### FIELD OF THE INVENTION

The present invention is directed to agricultural compositions comprising kinetin or salts, derivatives or conjugates thereof and an acid selected from the group consisting of hydrochloric acid, citric acid, sulfuric acid and mixtures thereof. The present invention is further directed to methods of improving plant growth comprising applying a composition of the present invention to a plant.

### BACKGROUND OF THE INVENTION

Growers continually attempt to grow the most productive crops possible to maximize yield. Plant growth regulators are among the best tools that growers can use to influence the growth of plants based on the restrictions of water and temperature. The effects of plant growth regulators on plants under different conditions can vary widely. Furthermore, it is difficult formulate plant growth regulators such that they can be stored for an extended period prior to application.

Kinetin is a plant growth regulator that regulates cell division in plant shoots and organs. Exogenous kinetin is applied in agricultural settings to increase yield of plants. Kinetins have also been shown to increase production in cotton under drought conditions. Bozsó et al. “Diverse Effect of Two Cytokinins, Kinetin and Benzyladenine, on Plant Development, Biotic Stress Tolerance, and Gene Expression”. Life (Basel) 2021 Dec: 11(12): 1404.

(S)-abscisic acid (“ABA”) is an endogenous plant growth regulator with many roles in growth and development. For example, ABA inhibits seed germination by antagonizing gibberellins that stimulate the germination of seeds. ABA promotes stress tolerance and maintains growth under stress conditions (see Sharp RE et al. J Exp Bot, 2004 55:2343-2351). Interestingly, several studies have shown that maintaining ‘normal’ ABA levels in well-watered plants is required to maintain shoot growth in tomato (Sharp RE et al., J Exp Bot, 2000 51:1575-1584) and Arabidopsis thaliana (LeNoble ME et al. J Exp Bot, 2004 55:237-245). Moreover, ABA is responsible for the development and maintenance of dormancy in seeds and woody plants, which when deficient in ABA often demonstrate pre-harvest sprouting of seeds due to a lack of dormancy induction.

Kinetin is notoriously difficult to formulate due to precipitation issues. Further despite use of mixtures of ABA and cytokinins disclosed in US 2021/0259244 and U.S. Pat. No. 9,023,762, there is no disclosure, to date, of a stable composition containing kinetin and ABA. Thus, there is a need in the art for a stable kinetin compositions and compositions containing kinetin and ABA.

### SUMMARY OF THE INVENTION

In one aspect, the present invention is directed to agricultural compositions comprising kinetin or salts, derivatives or conjugates thereof and an acid selected from hydrochloric acid, citric acid, sulfuric acid and mixtures thereof.

In another aspect, the present invention is directed to agricultural compositions comprising kinetin or salts, derivatives or conjugates thereof and citric acid, wherein the concentration ratio of kinetin or salts, derivatives or conjugates thereof to citric acid is at least about 1:7.5.

In another aspect, the present invention is directed to agricultural compositions comprising from about 1% to about 10% w/w (S)-abscisic acid, from about 1% to about 10% w/w kinetin or salts, derivatives or conjugates thereof and an acid selected from the group consisting of from about 1% to about 50% w/w hydrochloric acid, more preferably from about 1% to about 20% w/w, from about 7.5% to about 50% w/w citric acid and from about 1% to about 50% w/w sulfuric acid, more preferably from about 1% to about 10% w/w.

In another aspect, the present invention is directed to agricultural compositions comprising about 2% w/w (S)-abscisic acid, about 2% w/w kinetin or salts, derivatives or conjugates thereof and from about 15% to about 20% w/w citric acid.

In another aspect, the present invention is directed to methods of improving plant growth comprising applying an effective amount of a composition of the present invention to a plant.

### DETAILED DESCRIPTION OF THE INVENTION

Applicant has surprisingly discovered that the inclusion of hydrochloric acid, citric acid, and/or sulfuric acid to a non-aqueous liquid composition containing kinetin or salts, derivatives or conjugates thereof allows for greater solubility. Applicant has further surprisingly discovered that the inclusion of citric acid to a non-aqueous liquid composition containing kinetin or salts, derivatives or conjugates thereof at a concentration ratio of at least 7.5:1 allows for greater solubility. Finally, Applicant has surprisingly discovered that the inclusion of kinetin or salts, derivatives or conjugates thereof to a composition containing (S)-abscisic acid (“ABA”) and citric acid overcomes the negative effect on ABA stability caused by citric acid.

In one embodiment, the present invention is directed to agricultural compositions comprising kinetin or salts, derivatives or conjugates thereof and an acid selected from hydrochloric acid, citric acid, sulfuric acid and mixtures thereof.

In another embodiment, the present invention is directed to agricultural compositions comprising kinetin or salts, derivatives or conjugates thereof and citric acid, wherein the concentration ratio of kinetin or salts, derivatives or conjugates thereof to citric acid is at least about 1:7.5.

In another embodiment, the present invention is directed to agricultural compositions comprising kinetin or salts, derivatives or conjugates thereof, (S)-abscisic acid and an acid is selected from citric acid, sulfuric acid and mixtures thereof.

In another embodiment, the present invention is directed to agricultural compositions comprising kinetin or salts, derivatives or conjugates thereof, (S)-abscisic acid and citric acid, wherein the concentration ratio of kinetin or salts, derivatives or conjugates thereof to citric acid is at least about 1:7.5.

In a preferred embodiment, the concentration ratio of kinetin or salts, derivatives or conjugates thereof to citric acid is at least about 1:7.5, more preferably at least about 1:10. In a more preferred embodiment the concentration ratio of kinetin or salts, derivatives or conjugates thereof to citric acid is from about 1:7.5 to about 1:25, more preferably from about 1:7.5 to about 1:10 or from about 1:10 to about 1:25 and most preferably at about 1:7.5 or about 1:10.

In another preferred embodiment, the compositions of the present invention are liquid compositions.

In another preferred embodiment, the compositions of the present invention are non-aqueous liquid compositions.

In another preferred embodiment, the compositions of the present invention may comprise a carrier selected from the group consisting of propylene glycol and polyethylene glycol. In a more preferred embodiment, the carrier is selected from the group consisting of propylene glycol and polyethylene glycol 200.

In another preferred embodiment, kinetin is present in compositions of the present invention at concentration from about 1% to about 10% w/w, more preferably from about 1% to about 5% w/w, even more preferably from about 1% to about 3% w/w and most preferably at about 2% w/w.

Kinetin may be in the form of any agriculturally acceptable salt. Kinetin salts, derivatives and conjugates suitable for use in the present invention include, but are not limited to, kinetin hydrochloride, kinetin riboside, kinetin-3-glucoside, kinetin-9-glucoside, and kinetin riboside-5′-monophosphate sodium salt.

In another preferred embodiment, ABA is present in compositions of the present invention at concentration from about 1% to about 10% w/w, more preferably from about 1% to about 5% w/w and most preferably at about 2% w/w.

In another preferred embodiment, citric acid is present in compositions of the present invention at concentration from about 7.5% to about 50% w/w, more preferably from about 10% to about 25% w/w and most preferably at about 7.5% or about 10% w/w.

In another preferred embodiment, hydrochloric acid is present in compositions of the present invention at concentration from about 1% to about 50% w/w, more preferably from about 1% to about 20% w/w, even more preferably from about 4% to about 20% w/w and most preferably at about 4% w/w.

In another preferred embodiment, sulfuric acid is present in compositions of the present invention at concentration from about 1% to about 50% w/w, more preferably from about 1% to about 20% w/w, even more preferably from about 2% to about 10% w/w and most preferably at about 2% w/w.

In a preferred embodiment, carrier is present in compositions of the present invention at concentration from about 10% to about 90% w/w, more preferably from about 40% to about 80% w/w, even more preferably from about 60% to about 80% w/w and most preferably at about 70% w/w.

In another preferred embodiment, the compositions of the present invention further comprise a wetting agent, propyl gallate and lignin alkali.

Wetting agents suitable for use in the present invention include, but are not limited to, non-ionic surfactants, such as ethoxylated sorbitans including the polysorbates in the Tween® series such as Tween® 20-24, 40, 60, 80 and the like (Tween is a registered trademark of and available from Croda Americas LLC), polyoxyethylene glycol alkyl ethers including the Brij® series such as Brij® 35, 78, 98, 700, O20, C10, C2, C20, L4, L23, S20 and the like (Brij is a registered trademark of and available from Croda Americas LLC) and anionic surfactants such as, dioctyl sulfosuccinates including Aerosol® anionic surfactants such as 22, A-102, C-61, OT-75, OT-A, OT-B, and the like (Aerosol is a registered trademark of Cytec Technology Corp and available from Solvay). In a preferred embodiment the wetting agent is selected from the group consisting of polyoxyethylene vegetable-based fatty ether derived from cetyl alcohol (Brij® O20), polysorbate 20 (Tween® 20) and dioctyl sulfosuccinate sodium salt (Aerosol® OT-B).

In a preferred embodiment, the one or more wetting agents are present in compositions of the present invention at concentration from about 1% to about 10% w/w, more preferably from about 2% to about 6% w/w and most preferably at about 4% w/w.

In a preferred embodiment, compositions of the present invention may contain one or more antioxidants. Antioxidants suitable for use in the present invention includes, but is not limited to, propyl gallate, ethoxyquin, butylated hydroxyanisole, butylated hydroxytoluene and tertiary butylhydroquinone.

In a preferred embodiment, antioxidants are present in compositions of the present invention at concentration from about 0.01% to about 5% w/w, more preferably from about 0.1% to about 1% w/w and most preferably at about 0.3% w/w.

In another preferred embodiment, compositions of the present invention may contain a color stabilizer. Color stabilizers suitable for use in the present invention include, but are not limited to, lignin alkali.

In a preferred embodiment, color stabilizers are present in compositions of the present invention at concentration from about 0.01% to about 5% w/w, more preferably from about 0.05% to about 2% w/w and most preferably at about 0.1% w/w.

In another embodiment, the present invention is directed to methods of improving plant growth comprising applying an effective amount of a composition of the present invention to a plant.

In another embodiment, the plant is a monocotyledonous plant or a dicotyledonous plant. In a preferred embodiment the plant is selected from the group consisting of root, corm and tuber vegetable plants, bulb vegetable plants, leafy non-brassica vegetable plants, leafy brassica vegetable plants, succulent or dried legume plants, fruiting vegetable plants, cucurbit vegetable plants, citrus fruit plants, pome fruit plants, stone fruit plants, berry and small fruit plants, tree nut plants, cereal crops, forage and fodder grasses and hay, tall perennial grasses, non-grass animal feed plants, herb plants, spice plants, flower plants, bedding plants, ornamental flower plants, artichoke, asparagus, tropical fruit plants, hops, malanga, peanut, pomegranate plants, oil seed vegetable plants, tobacco plants, turf grass and watercress plant. In a more preferred embodiment, the plant is wheat, rice or barley and yet more preferably the cereal crop is wheat or rice.

In a preferred embodiment, the root, corm and tuber vegetable plants are selected from the group consisting of arracacha, arrowroot, Chinese artichoke, Jerusalem artichoke, garden beet, sugar beet, edible burdock, edible canna, carrot, bitter cassava, sweet cassava, celeriac, root chayote, turnip-rooted chervil, chicory, chufa, dasheen (taro), ginger, ginseng, horseradish, leren, turnip-rooted parsley, parsnip, potato, radish, oriental radish, rutabaga, salsify, black salsify, Spanish salsify, skirret, sweet potato, tanier, turmeric, turnip, yam bean, true yam, and cultivars, varieties and hybrids thereof.

In another preferred embodiment, the bulb vegetable plants are selected from the group consisting of fresh chive leaves, fresh Chinese chive leaves, bulb daylily, elegans hosta, bulb fritillaria, fritillaria leaves, bulb garlic, great-headed bulb garlic, serpent bulb garlic, kurrat, lady's leek, leek, wild leek, bulb lily, Beltsville bunching onion, bulb onion, Chinese bulb onion, fresh onion, green onion, macrostem onion, pearl onion, potato bulb onion, potato bulb, tree onion tops, Welsh onion tops, bulb shallot, fresh shallot leaves, and cultivars, varieties and hybrids thereof.

In a further embodiment, the leafy non-brassica vegetable plants are selected from the group consisting of Chinese spinach Amaranth, leafy Amaranth, arugula (roquette), cardoon, celery, Chinese celery, celtuce, chervil, Chinese spinach, edible-leaved chrysanthemum, garland chrysanthemum, corn salad, garden cress, upland cress, dandelion, dandelion leaves, sorrels (dock), endive (escarole), Florence fennel, head lettuce, leaf lettuce, orach, parsley, garden purslane, winter purslane, radicchio (red chicory), rhubarb, spinach, New Zealand spinach, vine spinach, Swiss chard, Tampala, and cultivars, varieties and hybrids thereof.

In another embodiment, the leafy brassica vegetable plants are selected from the group consisting of broccoli, Chinese broccoli (gai lon), broccoli raab (rapini), Brussels sprouts, cabbage, Chinese cabbage (bok choy), Chinese napa cabbage, Chinese mustard cabbage (gai choy), cauliflower, cavalo broccoli, collards, kale, kohlrabi, mizuna, mustard greens, mustard spinach, rape greens, turnip greens and cultivars, varieties and hybrids thereof. In yet another embodiment, the succulent or dried vegetable legumes are selected from the group consisting of Lupinus beans, Phaseolus beans, Vigna beans, broad beans (fava), chickpea (garbanzo), guar, jackbean, lablab bean, lentil, Pisum peas, pigeon pea, sword bean, peanut, and cultivars, varieties and hybrids thereof. In a preferred embodiment, the Lupinus beans include grain lupin, sweet lupin, white lupin, white sweet lupin, and hybrids thereof. In another preferred embodiment, the Phaseolus beans include field bean, kidney bean, lima bean, navy bean, pinto bean, runner bean, snap bean, tepary bean, wax bean, and hybrids thereof. In yet another preferred embodiment, the Vigna beans include adzuki bean, asparagus bean, blackeyed bean, catjang, Chinese longbean, cowpea, Crowder pea, moth bean, mung bean, rice bean, southern pea, urd bean, yardlong bean, and hybrids thereof. In another embodiment, the Pisum peas include dwarf pea, edible-podded pea, English pea, field pea, garden pea, green pea, snow pea, sugar snap pea, and hybrids thereof. In a preferred embodiment, the dried vegetable legume is soybean. In a more preferred embodiment, the dried vegetable legume is genetically modified soybean.

In a further embodiment, the fruiting vegetable plants are selected from the group consisting of bush tomato, cocona, currant tomato, garden huckleberry, goji berry, groundcherry, martynia, naranjilla, okra, pea eggplant, pepino, bell peppers, non-bell peppers, roselle, eggplant, scarlet eggplant, African eggplant, sunberry, tomatillo, tomato, tree tomato, and cultivars, varieties and hybrids thereof. In a preferred embodiment, the peppers include bell peppers, chili pepper, cooking pepper, pimento, sweet peppers, and hybrids thereof.

In an embodiment, the cucurbit vegetable plants are selected from the group consisting of Chayote, Chayote fruit, waxgourd (Chinese preserving melon), citron melon, cucumber, gherkin, edible gourds, Momordica species, muskmelons, pumpkins, summer squashes, winter squashes, watermelon, and cultivars, varieties and hybrids thereof. In a preferred embodiment, edible gourds include hyotan, cucuzza, hechima, Chinese okra, and hybrids thereof. In another preferred embodiment, the Momordica vegetables include balsam apple, balsam pear, bittermelon, Chinese cucumber, and hybrids thereof. In another preferred embodiment, the muskmelon includes true cantaloupe, cantaloupe, casaba, crenshaw melon, golden pershaw melon, honeydew melon, honey balls, mango melon, Persian melon, pineapple melon, Santa Claus melon, snake melon, and hybrids thereof. In yet another preferred embodiment, the summer squash includes crookneck squash, scallop squash, straightneck squash, vegetable marrow, zucchini, and hybrids thereof. In a further preferred embodiment, the winter squash includes butternut squash, calabaza, hubbard squash, acorn squash, spaghetti squash, and hybrids thereof.

In another embodiment, the citrus fruit plants are selected from the group consisting of limes, calamondin, citron, grapefruit, Japanese summer grapefruit, kumquat, lemons, Mediterranean mandarin, sour orange, sweet orange, pummelo, Satsuma mandarin, tachibana orange, tangelo, mandarin tangerine, tangor, trifoliate orange, uniq fruit, and cultivars, varieties and hybrids thereof. In a preferred embodiment, the limes are selected from the group consisting of Australian desert lime, Australian finger lime, Australian round lime, Brown River finger lime, mount white lime, New Guinea wild lime, sweet lime, Russell River lime, Tahiti lime, and hybrids thereof.

In an embodiment, the pome fruit plants are selected from the group consisting of apple, azarole, crabapple, loquat, mayhaw, medlar, pear, Asian pear, quince, Chinese quince, Japanese quince, tejocote, and cultivars, varieties and hybrids thereof.

In another embodiment, the stone fruit plants are selected from the group consisting of apricot, sweet cherry, tart cherry, nectarine, peach, plum, Chicksaw plum, Damson plum, Japanese plum, plumcot, fresh prune, and cultivars, varieties and hybrids thereof.

In a further embodiment, the berries and small fruit plants are selected from the group consisting of Amur river grape, aronia berry, bayberry, bearberry, bilberry, blackberry, blueberry, lowbush blueberry, highbush blueberry, buffalo currant, buffaloberry, che, Chilean guava, chokecherry, cloudberry, cranberry, highbush cranberry, black currant, red currant, elderberry, European barberry, gooseberry, grape including wine and table grapes, edible honeysuckle, huckleberry, jostaberry, Juneberry (Saskatoon berry), lingonberry, maypop, mountain pepper berries, mulberry, muntries, native currant, partridgeberry, phalsa, pincherry, black raspberry, red raspberry, riberry, salal, sea buckthorn, serviceberry, strawberry, wild raspberry, and cultivars, varieties and hybrids thereof. In a preferred embodiment, the blackberries include Andean blackberry, arctic blackberry, bingleberry, black satin berry, boysenberry, brombeere, California blackberry, Chesterberry, Cherokee blackberry, Cheyenne blackberry, common blackberry, coryberry, darrowberry, dewberry, Dirksen thornless berry, evergreen blackberry, Himalayaberry, hullberry, lavacaberry, loganberry, lowberry, Lucreliaberry, mammoth blackberry, marionberry, mora, mures deronce, nectarberry, Northern dewberry, olallieberry, Oregon evergreen berry, phenomenalberry, rangeberry, ravenberry, rossberry, cane berry, Shawnee blackberry, Southern dewberry, tayberry, youngberry, zarzamora, and hybrids thereof.

In another embodiment, the tree nut plants are selected from the group consisting of almond, beech nut, Brazil nut, Brazilian pine, bunya, butternut, bur oak, Cajou nut, candlenut, cashew, chestnut, chinquapin, coconut, coquito nut, dika nut, gingko, Guiana chestnut, hazelnut (filbert), heartnut, hickory nut, Japanese horse-chestnut, macadamia nut, mongongo nut, monkey-pot, monkey puzzule nut, Okari nut, Pachira nut, peach palm nut, pecan, Pili nut, pistachio, Sapucaia nut, tropical almond, black walnut, English walnut, yellowhorn, and cultivars, varieties and hybrids thereof.

As used herein, the term “cereal crops” refers to barley, buckwheat, pearl millet, proso millet, oats, rice, rye, sorghum (milo), sorghum species, grain sorghum, sudangrass (seed), teosinte, triticale, wheat, wild rice, and cultivars, varieties and hybrids thereof. In a more preferred embodiment, the cereal crop is selected from rice, oats, wheat, triticale, barley and rye. In an even more preferred embodiment, the cereal crop is wheat, rice or barley and yet more preferably the cereal crop is wheat or rice.

In yet another embodiment, the grass forage, fodder and hay are selected from the group consisting of grasses that are members of the Gramineae family except sugarcane and those species included in the cereal crops group, pasture and range grasses, and grasses grown for hay or silage. In further embodiments, the Gramineae grasses may be green or cured.

In yet another embodiment, the tall perennial grasses are those of the genus Saccharum, including sugarcanes and ornamental grasses.

In an embodiment, the non-grass animal feeds are selected from the group consisting of alfalfa, velvet bean, trifolium clover, melilotus clover, kudzu, lespedeza, lupin, sainfoin, trefoil, vetch, crown vetch, milk vetch, and cultivars, varieties and hybrids thereof.

In another embodiment, the herbs and spice plants are selected from the group consisting of allspice, angelica, anise, anise seed, star anise, annatto seed, balm, basil, borage, burnet, chamomile, caper buds, caraway, black caraway, cardamom, cassia bark, cassia buds, catnip, celery seed, chervil, chive, Chinese chive, cinnamon, clary, clove buds, coriander leaf, coriander seed, costmary, culantro leaves, culantro seed, cilantro leaves, cilantro seed, cumin, dillweed, dill seed, fennel, common fennel, Florence fennel seed, fenugreek, grains of paradise, horehound, hyssop, juniper berry, lavender, lemongrass, leaf lovage, seed lovage, mace, marigold, marjoram, mint, mustard seed, nasturtium, nutmeg, parsley, pennyroyal, black pepper, white pepper, poppy seed, rosemary, rue, saffron, sage, summer savory, winter savory, sweet bay, tansy, tarragon, thyme, vanilla, wintergreen, woodruff, wormwood, and cultivars, varieties and hybrids thereof. In a preferred embodiment, the mints are selected from the group consisting of spearmint, peppermint, and hybrids thereof.

In yet another embodiment, artichokes are selected from the group consisting of Chinese artichoke, Jerusalem artichoke, and cultivars, varieties and hybrids thereof.

In an embodiment, the tropical fruit plants are selected from the group consisting of anonna, avocado, fuzzy kiwifruit, hardy kiwifruit, banana, plantain, caimito, carambola (star fruit), guava, longan, sapodilla, papaya, passion fruit, mango, lychee, jackfruit, dragon fruit, mamey sapote, coconut cherimoya, canistrel, monstera, wax jambu, pomegranate, rambutan, pulasan, Pakistani mulberry, langsat, chempedak, durian, fig pineapple, jaboticaba, mountain apples, and cultivars, varieties and hybrids thereof.

In a further embodiment, the oil seed vegetable plants are selected from the group consisting of borage, calendula, castor oil plant, tallowtree, cottonseed, crambe, cuphea, echium, euphorbia, evening primrose, flax seed, gold of pleasure, hare's ear, mustard, jojoba, lesquerella, lunaria, meadowfoam, milkweed, niger seed, oil radish, poppy seed, rosehip, sesame, stokes aster, sweet rocket, tallowwood, tea oil plant, vermonia, canola, or oil rapeseed, safflower, sunflower, and cultivars, varieties and hybrids thereof.

In a further preferred embodiment, the plant is selected from the group consisting of corn, sorghum, millet and soybean. In a more preferred embodiment, the plant is corn or soybean, even more preferably the corn is selected from field corn, sweet corn, seed corn and popcorn. In a more preferred embodiment, the crop is genetically modified corn.

In another embodiment, the plant in which plant growth is improved is subject to an abiotic stress.

In another embodiment, the plant is subjected to drought stress. As used herein, “drought stress” refers to watering conditions wherein plant growth is significantly slowed as compared to those where water availability is sufficient to support optimal growth and development.

In a preferred embodiment, the compositions of the present invention are applied prior to or during the advent of abiotic stress. When the intended stress is drought, application of compositions of the present invention occurs prior to or during drought stress.

In another preferred embodiment, from about 1 to 1,000 parts per million (“ppm”) of ABA are applied to the plant, more preferably from about 10 to about 1,000 ppm, even more preferably from about 10 to about 100 ppm and yet even more preferably from about 10 to about 30 ppm and yet even more preferably at about 30 ppm.

In another preferred embodiment, from about 1 to 1,000 ppm of kinetin are applied to the plant, more preferably from about 5 to 1,000 ppm, even more preferably from about 5 to about 100 ppm and yet even more preferably from about 5 to about 45 ppm or from about 5 to about 10 ppm or from about 30 to about 45 ppm and yet even more preferably at about 10 ppm or about 30 ppm.

In another preferred embodiment, ABA is applied to the plant at a rate from about 0.1 to about 100 grams per hectare (“g/HA”), more preferably from about 1 to about 20 g/HA and most preferably from about 2 to about 12 g/HA.

In another preferred embodiment, kinetin are applied to the plant at a rate from about 0.1 to about 100 g/HA, more preferably from about 0.5 to about 10 g/HA and most preferably from about 1 to about 6 g/HA.

The compositions of the present invention can be applied by any convenient means. Those skilled in the art are familiar with the modes of application that include foliar applications such as spraying; soil applications including spraying, in-furrow treatments, or side-dressing. In a preferred embodiment, compositions of the present invention are applied to the plant as a spray and even more preferably as a foliar spray.

As used herein, “non-aqueous” refers to a composition containing less than 5% w/w water, preferably less than 4% w/w, more preferably less than 3% w/w, even more preferably less than 2% w/w, yet even more preferably less than 1% w/w.

As used herein, “effective amount” refers to the amount of the ABA and/or kinetin that will improve growth, drought stress tolerance, and/or yield. The “effective amount” will vary depending on the ABA and kinetin concentrations, the plant species or variety being treated, the severity of the stress, the result desired, and the life stage of the plants, among other factors. Thus, it is not always possible to specify an exact “effective amount.” However, an appropriate “effective amount” in any individual case may be determined by one of ordinary skill in the art.

As used herein, “improving” means that the plant has more of the quality than the plant would have had it if it had not been treated by methods of the present invention.

As used herein, all numerical values relating to amounts, weight percentages and the like are defined as “about” or “approximately” each particular value, namely, plus or minus 10 % (±10 %). For example, the phrase “at least 5% by weight” is to be understood as “at least 4.5 % to 5.5 % by weight.” Therefore, amounts within 10% of the claimed values are encompassed by the scope of the claims.

The articles “a,” “an” and “the” are intended to include the plural as well as the singular, unless the context clearly indicates otherwise.

The disclosed embodiments are simply exemplary embodiments of the inventive concepts disclosed herein and should not be considered as limiting, unless the claims expressly state otherwise.

The following examples are intended to illustrate the present invention and to teach one of ordinary skill in the art how to use the formulations of the invention. They are not intended to be limiting in any way.

EXAMPLES

### Example 1—Kinetin Formulation Stability

### Method

Kinetin was formulated in propylene glycol or polyethylene glycol 200 at 0.5%, 0.75% or 1% w/w at between 60 and 70 degrees Celsius and cooled to ambient temperature and measured for solubilization. Solubilized formulations were further stored at room temperature and at 5 degrees Celsius for 1 week.

### Results

Kinetin completely solubilized at 0.5% w/w in propylene glycol but was not stable after storage for 1 week at room temperature. Kinetin completely solubilized at 0.5% w/w in polyethylene glycol 200 and stable at room temperature and 5 degrees Celsius. Kinetin completely solubilized at 0.75% w/w in polyethylene glycol 200 but was not stable after storage for 1 week at room temperature. Kinetin was only partially soluble at 0.75% and 1% w/w in propylene glycol and at 1% w/w in polyethylene glycol. Thus, kinetin at about 1% w/w is not solubilized or stable in non-aqueous formulations.

### Example 2—Kinetin Formulation Stability with Acids

### Method

Kinetin was formulated in propylene glycol or polyethylene glycol 200 at 2% w/w with the addition of one of the following acids and concentration ratios (kinetin to acid): 37% hydrochloric acid (1:2), citric acid (1:10), acetic acid (1:10), malic acid (1:10), 80% lactic acid (1:10), formic acid (1:10), ascorbic acid (1:10), phosphoric acid (1:2), sulfuric acid (1:1) and propanoic acid (1:10) and measured for solubilization. Solubilized formulations were further stored at 5 degrees Celsius, ambient temperature, 8 weeks at 40 degrees Celsius, 2 weeks at 54 degrees Celsius.

### Results

Only hydrochloric acid, citric acid, and sulfuric acid allowed for complete solubilization and stability of 2% w/w kinetin. Malic acid, lactic acid and formic acid were capable of dissolving kinetin, but precipitation occurred in less than 1 weeks at ambient temperature. Acetic acid, phosphoric acid, propanoic acid and ascorbic acid were incapable of dissolving kinetin.

### Example 3—Kinetin Formulation Stability with Citric and/or Hydrochloric Acid

### Method

Kinetin was formulated in propylene glycol at 2% w/w with the addition of 2% w/w citric acid and 1% w/w hydrochloric acid or 20% w/w citric acid and measured for solubilization and stability. Solubilized formulations were stored at 5 degrees Celsius for 8 weeks, 40 degrees Celsius for 8 weeks and 54 degrees Celsius for 2 weeks.

### Results

Each formulation resulted in less than a 5% loss of kinetin demonstrating chemical stability.

### Example 4—Effect of Citric Acid Concentration on Kinetin Stability

### Method

Kinetin was formulated in propylene glycol at 2% w/w with the addition of either 10%, 15% or 20% w/w citric acid and measured for solubilization and stability. Solubilized formulations were stored at 5 degrees Celsius for 8 weeks, 40 degrees Celsius for 8 weeks and 54 degrees Celsius for 2 weeks.

### Results

The 10% w/w citric acid formulation only partially solubilized 2% w/w kinetin. The 15% and the 20% w/w citric acid formulations completely solubilized the 2% w/w kinetin formulation and were chemically stable for 2 weeks at 54 degrees Celsius. However, the 15% w/w citric acid formulation was physically unstable at room temperature for 2 months and 40 degrees Celsius for 8 weeks. The 20% w/w citric acid formulation was physically stable room temperature for 2 months and 40 degrees Celsius for 8 weeks. Thus, a concentration ratio of at least 1:7.5 kinetin to citric acid is required to provide chemical stability and a concentration ratio of at least 1:10 kinetin to citric acid is desirable for long-term physical stability.

Example 5—ABA Formulation Stability with Citric and/or Hydrochloric Acid

### Method

ABA was formulated in propylene glycol at 2% w/w with the addition of 2% w/w citric acid and 1% w/w hydrochloric acid or 20% w/w citric acid and measured for solubilization and stability. Solubilized formulations were stored at 5 degrees Celsius for 2 weeks and 54 degrees Celsius for 2 weeks.

### Results

The 20% citric acid formulation resulted in a 12% loss in ABA. The 2% w/w citric acid/ 1% w/w hydrochloric acid formulation resulted in 100% loss of ABA. Thus, neither citric acid nor hydrochloric acid are capable of stabilizing ABA.

### Example 6—ABA+Kinetin Formulation Stability with Citric and/or Hydrochloric Acid

### Method

ABA and kinetin were co-formulated in propylene glycol at 2% w/w each with the addition of 2% w/w citric acid and 1% w/w hydrochloric acid or 20% w/w citric acid and measured for solubilization and stability. Solubilized formulations were stored at 5 degrees Celsius for 2 weeks and 54 degrees Celsius for 2 weeks.

### Results

The 20% citric acid formulation resulted in less than 5% loss of either ABA or kinetin. The 2% w/w citric acid/ 1% w/w hydrochloric acid formulation resulted in 5% loss of kinetin and 60% loss of ABA. Thus, hydrochloric acid cannot be included in a formulation containing ABA. However, the addition of kinetin to a formulation containing ABA and citric acid alone results in stable ABA.

What is claimed is:

1. An agricultural composition comprising kinetin or salts, derivatives or conjugates thereof and an acid selected from hydrochloric acid, citric acid, sulfuric acid and mixtures thereof.

2. The composition of claim 1, wherein the acid is citric acid and wherein the concentration ratio of kinetin or salts, derivatives or conjugates thereof to citric acid is at least about 1:7.5.

3. The composition of claim 2, wherein the concentration ratio of kinetin or salts, derivatives or conjugates thereof to citric acid is from about 1:7.5 to about 1:25.

4. The composition of claim 3, wherein the concentration ratio of kinetin or salts, derivatives or conjugates thereof to citric acid is from about 1:7.5 to about 1:10.

5. The composition of claim 1 further comprising (S)-abscisic acid, wherein the acid is selected from citric acid, sulfuric acid and mixtures thereof.

6. The composition of claim 1, further comprising a carrier selected from the group consisting of propylene glycol and polyethylene glycol.

7. The composition of claim 1, wherein the composition is a liquid.

8. The composition of claim 7, wherein the composition is non-aqueous.

9. An agricultural composition comprising from about 1% to about 10% w/w kinetin or salts, derivatives or conjugates thereof and an acid selected from the group consisting of from about 1% to about 50% hydrochloric acid, from about 7.5% to about 50% w/w citric acid and from about 1% to about 50% sulfuric acid, wherein w/w denotes weight by total weight of the composition.

10. The composition of claim 9, wherein the acid is citric acid and wherein concentration ratio of kinetin or salts, derivatives or conjugates thereof to citric acid is at least about 1:7.5 and wherein w/w denotes weight by total weight of the composition.

11. The composition of claim 9, further comprising from about 1% to about 10% w/w (S)-abscisic acid, wherein the acid is selected from citric acid, sulfuric acid and mixtures thereof.

12. The composition of claim 9, wherein the concentration of kinetin or salts, derivatives or conjugates thereof is from about 1% to about 5% w/w.

13. The composition of claim 10, wherein the concentration of citric acid is from about 10% to about 25% w/w.

14. The composition of claim 10, wherein the concentration ratio of kinetin or salts, derivatives or conjugates thereof to citric acid is from about 1:7.5 to about 1:25.

15. The composition of claim 10, wherein the concentration ratio of kinetin or salts, derivatives or conjugates thereof to citric acid is from about 1:7.5 to about 1:10.

16. The composition of claim 9, further comprising a carrier selected from the group consisting of propylene glycol and polyethylene glycol.

17. The composition of claim 16, wherein the concentration of the carrier is from about 10% to about 90% w/w.

18. An agricultural composition comprising about 2% w/w (S)-abscisic acid, about 2% w/w kinetin or salts, derivatives or conjugates thereof and from about 15% to about 20% w/w citric acid and wherein w/w denotes weight by total weight of the composition.

19. A method of improving plant growth comprising applying an effective amount of a composition of claim 1 to a plant.
